(19) United States
(12) Patent Application Publication
(10) Pub. No.: US 2019/0079209 A1
(43) Pub. Date: Mar. 14, 2019

(54) Multi-Well Resistivity Anisotropy Modeling, Used to Improve the Evaluation of Thinly Bedded Oil and Gas Reservoirs

(71) Applicant: Richard Douglas Aldred, Toowong (AU)

(72) Inventor: Richard Douglas Aldred, Toowong (AU)

(21) Appl. No.: 15/705,224

(22) Filed: Sep. 14, 2017

(51) Int. Cl. G01V 1/48; E21B 49/00; G01V 3/38

(52) U.S. Cl. CPC G01V 1/48; E21B 49/003; G01V 2210/1429; G01V 2200/16; G01V 3/38

(57) ABSTRACT

A method of analyzing well log data from multiple wells intersecting thinly bedded laminated oil and gas reservoirs to quantify the presence and volume of hydrocarbons. The method is applicable for mature fields which are under review to detect hydrocarbons which have been by-passed during earlier field developments. It uses conventional resistivity measurements to detect electrical anisotropy in each formation based on changes in log response from well to well owing to each well intersecting the formation at varying degrees of relative dip. The processing technique produces horizontal and vertical resistivity curves which are then input to interpretation techniques which have previously been developed to interpret data from multi-component (tri-axial) induction logging tools.

### BACKGROUND OF THE INVENTION

The invention is related to the interpretation of measurements made by well logging instruments used in boreholes in order to evaluate geological formations and the fluids, either hydrocarbons or water, contained in them.

A number of measurements are used in combination to determine the amount of pore space within a rock and then the electrical conductivity (or the inverse of conductivity which is resistivity) of the rock is measured in order to determine if the pore space is filled with water or hydrocarbons. Rocks containing hydrocarbons are generally resistive while rocks containing water are usually less resistive. Some rocks, known as shales, contain fine grained clay minerals which have water ‘bound’ to them and are conductive. The presence of shale in a rock reduces the overall resistivity and makes the rock appear to be water bearing when it may actually contains hydrocarbons.

Equations are used which determine the amount of water in a formation as a proportion of the total pore space. These equations counter the effects of shale to give more accurate determination of the presence of water and hydrocarbons. However, the way in which the shales are distributed in the rock has an impact on its resistivity, with shale which is in layers allowing the current to pass through easier than shale which is dispersed through the formation.

When a borehole is drilled vertically through horizontally layered geological formations the measured current from most logging tools passes parallel to the layering. The presence of thin layers of conductive shale allows the current to pass through the rock, meaning that the shales dominate the resistivity measurement. Most accessible hydrocarbons in laminated formations of shale and sand are contained in the sand layers, so the dominance of the shale on the measurement means that it is difficult to identify and quantify the hydrocarbons.

When a borehole is drilled at high angle through the formation or the formation is dipping in relation to the borehole, the electrical current passes through both the shale and sand layers so it is less dominated by the shale and the resistivity is higher than in the same formation drilled with a vertical borehole.

In the late 1990's some new resistivity logging tools were developed, specifically for thin beds, which pass currents through the formation in multiple directions in order to directly measure the electrical anisotropy. An example is the multicomponent tri-axial induction tool described in Kriegshauser et al (2000). The measurements output from these tools are the horizontal and vertical resistivities (Rh and Rv).

Dedicated interpretation methods have been developed for these measurements, including the Laminated Shaly Sand Analysis (LSSA), which have been found to accurately determine the quantities of fluids in the sand layers of laminated formations with low uncertainty. In addition to quantifying fluid content LSSA is also able to distinguish between shaly sand rocks which are laminated and those containing similar quantities of sand and shale but which are not in laminations. This is a very common issue where many fields have rocks which would have been laminar when initially deposited, but which were subject to deformation of the laminations due to various different factors. It is very difficult to distinguish the two rock types using most conventional measurements.

The new tools were first used in the late 1990's and early 2000's, but there are many oil and gas fields around the world which were developed prior to this time and many of these contain laminated and other types of shaly sand formations which have not previously been considered as hydrocarbon bearing reservoirs. As the mature fields are now being reviewed it is necessary to re-evaluate these formations to locate by-passed hydrocarbons.

### SUMMARY OF THE INVENTION

The invention is a new technique which detects electrical anisotropy from conventional resistivity logs in multiple wells, allowing the user to identify laminated hydrocarbon bearing intervals and create horizontal and vertical resistivity curves (Rh and Rv).

The electrical anisotropy of a formation is determined from changes in responses of conventional resistivity measurements in multiple wells with different angles of relative dip. Each analysis is limited to formations which exhibit similar characteristics on other logs and which are above the transition zone between hydrocarbon bearing and water bearing rock. This often means dividing the field into smaller areas where the formation is seen to be consistent. Rv and Rh curves are computed from conventional resistivity logs and modelled anisotropy, while Rv_sh and Rh_sh values are determined from resistivities in thick shale sequences in multiple wells. These four measurements are then used as input to the Laminated Shaly Sand Analysis.

In practice, conventional log interpretations are run over the entire formation assuming no laminated intervals. The interpretation from laminated formations using this new technique then overrides the conventional interpretation over specific laminated intervals which have been identified using this new technique.

### BRIEF DESCRIPTION OF DRAWINGS

In order for the present invention to be better understood the figures are included and referenced hereafter. It should be noted that the figures are given as an example only and in no way limit the scope of the invention.

FIG. 1 shows the effects of varying amounts of laminar shale on conventional resistivity measurements, using the parallel resistor model for Rh, and on vertical resistivity measurements using the series resistor model for Rv.

FIG. 2 compares resistivity responses in non-laminar shaly sands from the Juhasz equation with parallel resistor model Rh and series resistor model Rv resistivity responses.

FIG. 3 is an illustration of the Moran & Gianzero equation of apparent resistivity and relative dip given fixed values of Rh and Rv.

FIG. 4 shows multiple apparent resistivity responses (Ra) from relative dips in laminated shaly sands, compared to Rh and Rv measurements for the same formation. The curves representing responses at relative dips of less than 40° are very similar to the Rh curve and are not shown in this figure.

FIG. 5 illustrates how apparent resistivity varies with relative dip and shale volume in a laminated shaly sand. Each of the parallel curved lines represents the apparent resistivity in a laminated formation at a different relative dip angle, across the range of laminar shale volumes. The Moran & Gianzero equation curves are also shown for 50% and 100% laminar shale volumes.

FIG. 6 is a schematic showing wells intersecting a laminated formation at different angles of relative dip.

FIG. 7 shows the Moran & Gianzero equation curve fitted to data from seven wells from a portion of an example formation across a section of a field.

FIG. 8 is a shale anisotropy plot used to derive the values for Rh_shale and Rv_shale.

FIG. 9 is an illustration of the modeling technique combining the curves derived from the Moran & Gianzero equation with Rh and Rv modeling using the parallel and series resistor equations.

FIG. 10 shows data points from seven wells drilled in the same formation as FIG. 8 but showing no effects of electrical anisotropy.

### DETAILED DESCRIPTION OF THE INVENTION

### Resistivity Responses

The reason conventional resistivity measurements read such low values in laminated formations is that the current takes the path of least resistance, horizontally through the conductive shales. This can be illustrated by considering a parallel resistor model shown in equation 1 (for an explanation of terms see Nomenclature section below). If there are two components in the laminated formation, resistive hydrocarbon bearing sand layers and conductive shale layers, the parallel equation for horizontal resistivity can be written as follows:

$$\frac{1}{Rh} = \frac{1}{Rss} ( 1 - Vshl ) + \frac{1}{Rh\_sh} ( Vshl ) \qquad ( 1 )$$

Tri-axial tools produce both vertical and horizontal measurements for the formation. The vertical measurement is based on the current passing equally through both layer types, therefore the series conductor model is more appropriate, as shown in equation 2.

Rv=Rss(1−Vshl)+Rv_sh(Vshl) (2)

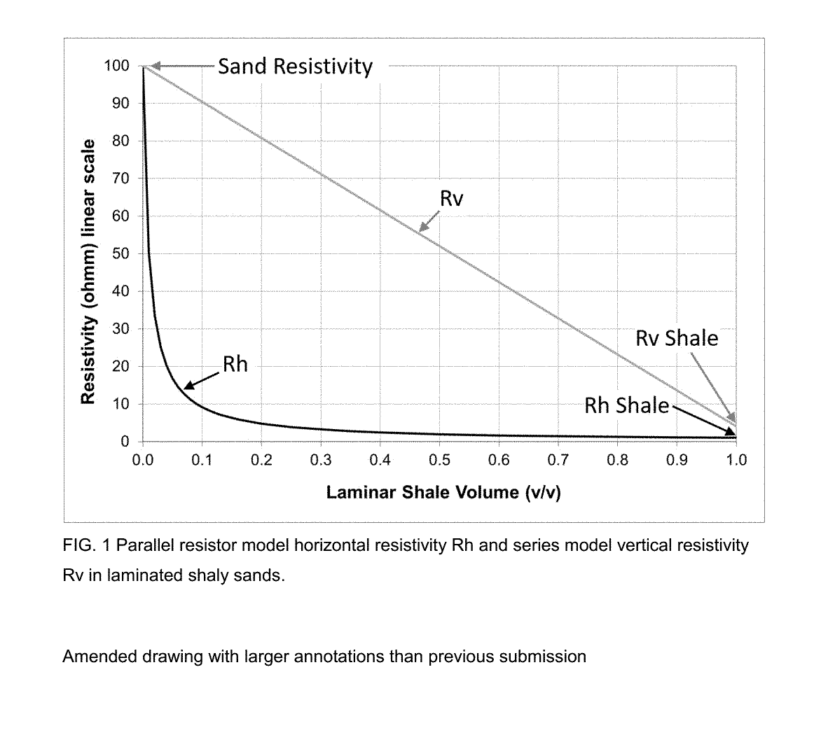

If the resistivity of the sand layers in the formation is 100 Ohm-m and the resistivity of the shale layers is 1 Ohm-m, the effects of the shale layers on the resistivity measurements are shown in FIG. 1. In this example laminar shale dominates the horizontal response while the vertical response is equally affected by both shale and sandstone.

Shale generally contains many minerals which are platy or elongated. During deposition these minerals tend to orientate along the bedding which means that at a micro scale shales tend to exhibit a degree of electrical anisotropy with lower resistivity along the bedding compared to perpendicular to the bedding. For this reason shale resistivities are considered differently in horizontal and vertical measurements. This anisotropy is in addition to the macro scale anisotropy observed in layered systems of shale and sandstone.

When dealing with resistivities, horizontal measurements are always considered to be parallel to the bedding of the rock while vertical measurements are those which are perpendicular to the bedding.

FIG. 1 clearly shows the large effect of even minor quantities of shale laminations on conventional horizontal resistivity, Rh. At just 10% laminar shale volume Rh has reduced from 100 Ohm-m to 10 Ohm-m. This diagram also illustrates the value of Rv and the degree of anisotropy present in a layered system.

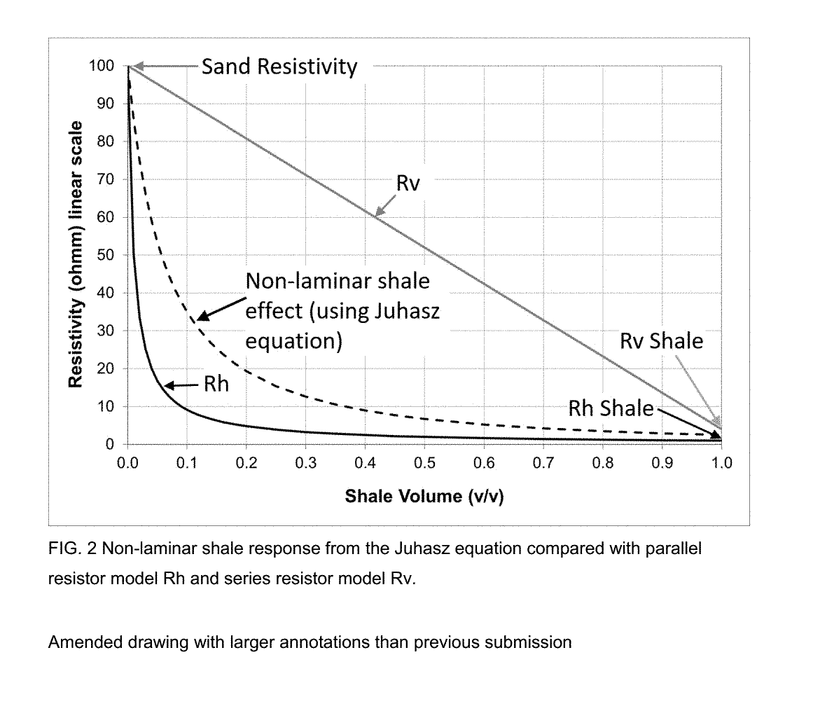

When the shales are not laminations but are instead dispersed throughout the sands they still have a large impact on resistivity. FIG. 2 shows the effects of non-laminar shale using the Juhasz equation. This indicates that in the bioturbated formations conventionally measured resistivities should be higher than in laminated formations. However, some bioturbated shaly sands do show a degree of horizontal alignment which means that the measured resistivities in vertical wells generally lie part way between the parallel resistor model values and the non-laminar model values.

### Effects of Relative Dip on Resistivity Logs

When wells are drilled at high angle through transversely anisotropic formations conventional resistivity measurements are affected by the anisotropy. The parallel resistor model shown in FIG. 1 only applies when there is low relative dip between tool and formation. As the relative dip increases the conventional measurement is no longer equivalent to the horizontal resistivity but instead is a combination of horizontal and vertical.

Moran and Gianzero (1979) described this effect and derived an equation for the apparent resistivity based on the coefficient of anisotropy and the relative dip between tool and formation (equations 3 and 4). They also noted that the same equation could be used for both laterolog and induction type resistivity logs.

$$\begin{matrix}Ra = \frac{λ Rh}{\sqrt{{λ}^{2} {cos}^{2} θ + {sin}^{2} θ}} & ( 3 ) \\ where λ = \sqrt{( Rv / Rh )} & ( 4 )\end{matrix}$$

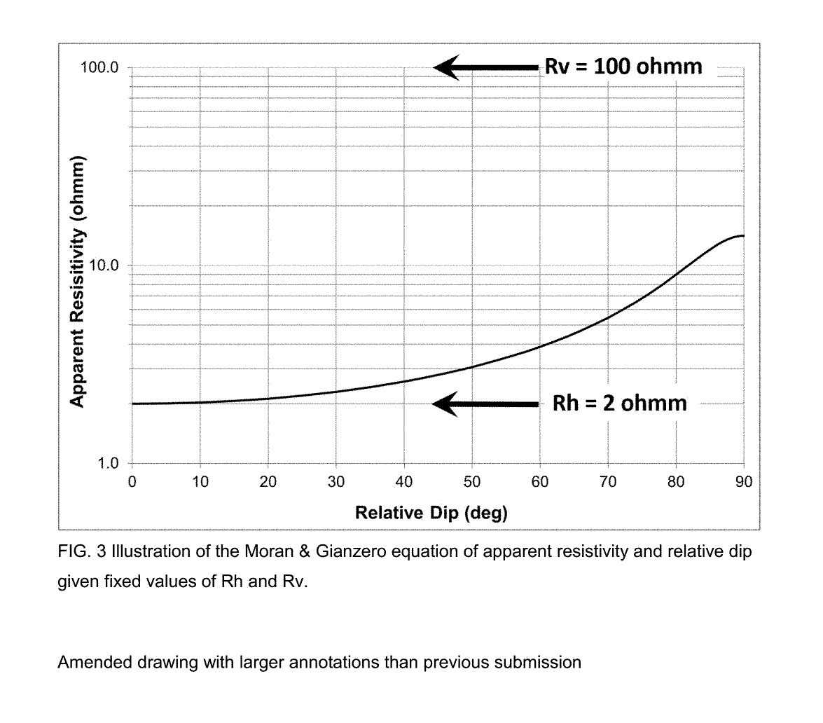

An illustration of the Moran & Gianzero equation relating apparent resistivity (Ra) to Relative Dip is shown in FIG. 3.

This concept was used by Bittar and Rodney (1996) when modeling the increase in resistivity seen in LWD measurements in high angle wells. They also described how the relationship changed for the phase shift measurements based on frequency and transmitter receiver spacing.

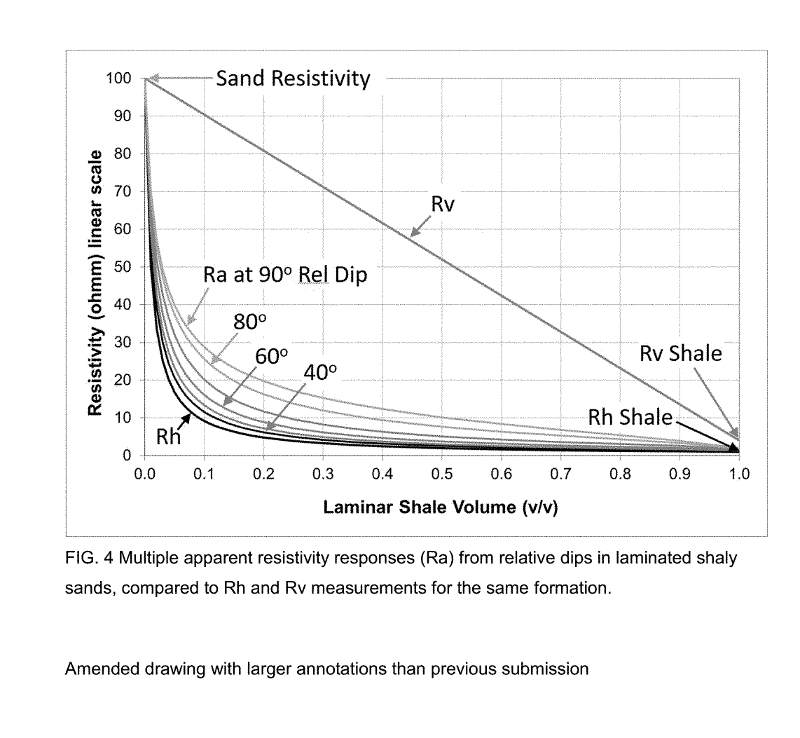

When the different angles of relative dip are considered, the plot of Rh and Rv with varying laminar shale volume can be modified to include the apparent resistivities measured by conventional tools, as shown in FIG. 4. The curves representing responses at relative dips of less than 40° are very similar to the Rh curve and are not shown in this figure.

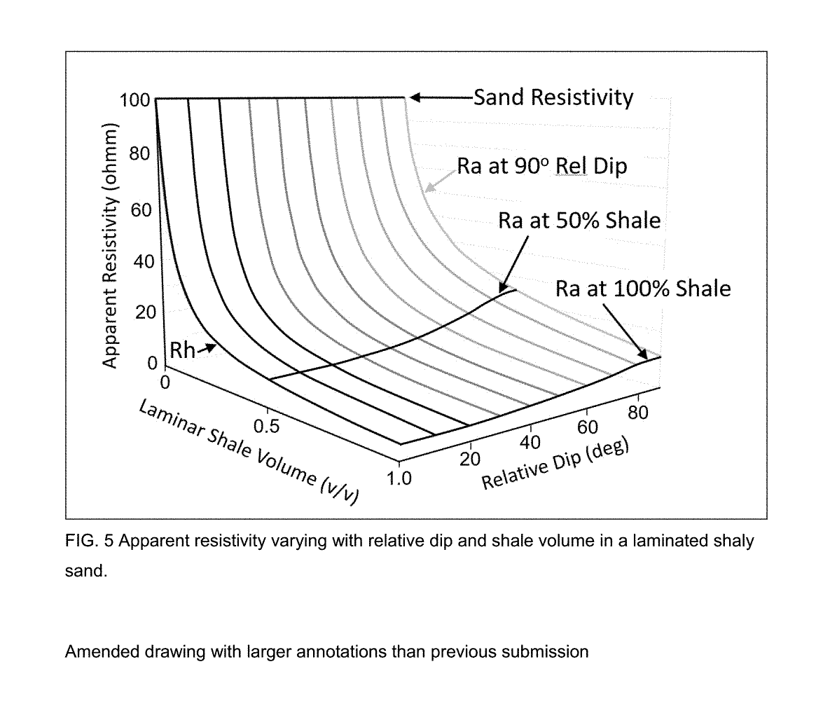

The combination of the Moran & Gianzero equation and the parallel resistivity equation is illustrated in the schematic three-dimensional diagram shown in FIG. 5. Each of the parallel curved lines represents the apparent resistivity in a laminated formation at a different relative dip angle, across the range of laminar shale volumes.

The Moran & Gianzero equation curves are also shown if FIG. 5 for 50% and 100% laminar shale volumes.

### Resistivity Anisotropy Modeling

Many mature shaly sand hydrocarbon reservoirs have been developed by drilling multiple deviated wells from offshore platforms. When multiple wells have intersected the same laminated formation the effects of anisotropy on the resistivity measurements are often observed, with higher resistivities seen in the higher angle wells.

Attempts have been made in the past to model the electrical properties of the formations to reflect the directional nature of measurements such as the Archie cementation exponent cm′ and saturation exponent ‘n’ (Herrick and Kennedy, 1996). This means that combined interpretations of many wells across a field require the use of electrical properties which vary with relative dip.

Instead of varying properties, this new alternative approach uses the observed effects of anisotropy to determine horizontal and vertical resistivities for the formation. Synthetic horizontal resistivity (Rh) and vertical resistivity (Rv) curves are calculated and input into an interpretation model such as LSSA, giving significantly reduced uncertainty in the results. In addition this technique allows for the differentiation between laminar and bioturbated formations.

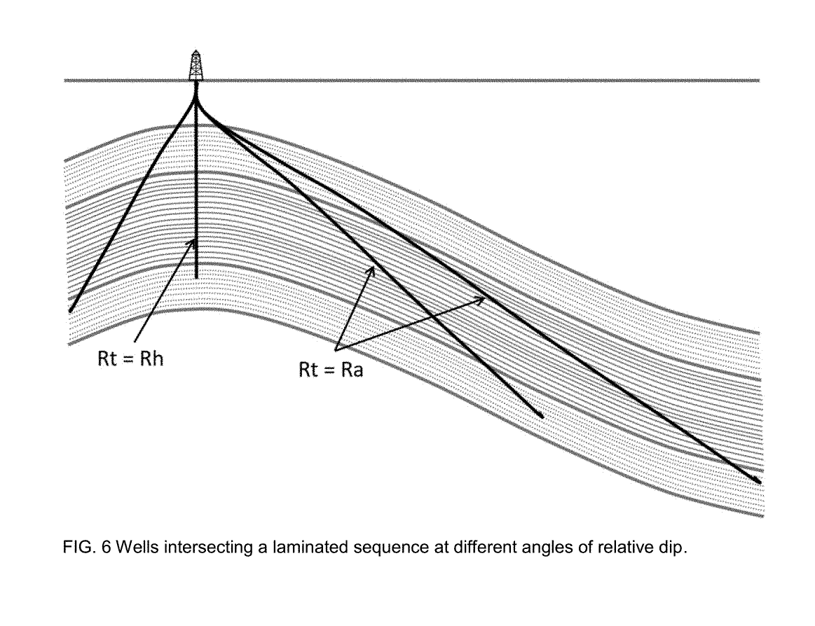

FIG. 6 is a schematic illustration of a field where one vertical well and a number of high angle wells have penetrated a laminar formation. In the vertical well, where relative dip is negligible, a conventional Rt measurement will equate to Rh. In the high angle wells Rt is a combination of Rh and Rv for the formation, so this is called apparent resistivity (Ra).

### Methodology

Values from each specific formation in different wells are plotted against relative dip to define the curve based on the Moran & Gianzero equation. These values can be average resistivities for the formation within a small Vsh range or simply picked by the interpreter to represent a specific part of the formation in each well.

As there is usually a variation in the shale content at different depths in the formation it is important to pick values for the same shale content for comparison. It is also essential that only intervals above the transition zone are selected.

A commercially available non-linear least squares curve fitting technique is then used to determine the best fit of the data points to a curve defined by the Moran & Gianzero equation. Values for Rh and Rv used in the equation are varied to minimize the total error between the resulting curve and the observed data points. The output of this process is a value for Rh and Rv for the formation at the given volume of laminar shale.

It is possible to fit the Moran & Gianzero curve to only two data points (two wells), but very small changes in the values for relative dip, apparent resistivity or Vsh can lead to large changes in computed Rh and Rv. The more data points that are used the lower the uncertainty will be, assuming the points lie on or near a trend denoting anisotropy.

It is advisable to monitor the possible uncertainties in a trend by monitoring the impact of excluding certain points or making small changes to the values of individual points.

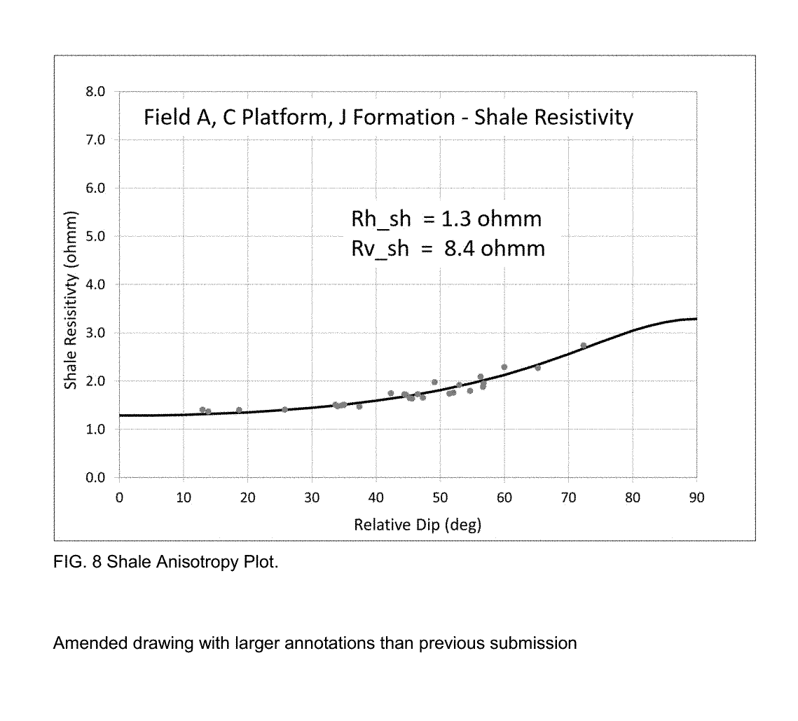

The second step is to create a similar plot for the shales in the formation, as shown in FIG. 8. Shale generally shows electrical anisotropy so a plot of apparent shale resistivity against relative dip is required to determine the Rh_sh and Rv_sh values for the formation. Crossplots of Rt against Vsh are used from each well and the trends in the shalier formations are extrapolated to give resistivity values for 100% shale.

The shale anisotropy plot makes the assumption that the laminar shales are similar to the thicker shales in the formation. While this may not be the case, the plot provides a starting point for the interpretation and these values can be adjusted later if required.

Having determined Rh and Rv for the formation at the observed laminar shale content, and having determined Rh_sh and Rv_sh from the shale anisotropy plot, log curves of Rh and Rv are calculated for any volume of laminar shale using the parallel and series resistor equations, as shown in equations 5, 6 and 7.

$$\begin{matrix}\frac{1}{Rh} = \frac{1}{Rssm} ( 1 - Vshm ) + \frac{1}{Rh\_sh} ( Vshm ) & ( 5 ) \\ Rv = Rssm ( 1 - Vshm ) + Rv\_sh ( Vshm ) \\ where ; & ( 6 ) \\ Rssm = \frac{Rv\_m - Rv\_sh \cdot Vshm}{1 - Vshm} & ( 7 )\end{matrix}$$

and; Vshm is the Vsh value used in the initial modeling process.

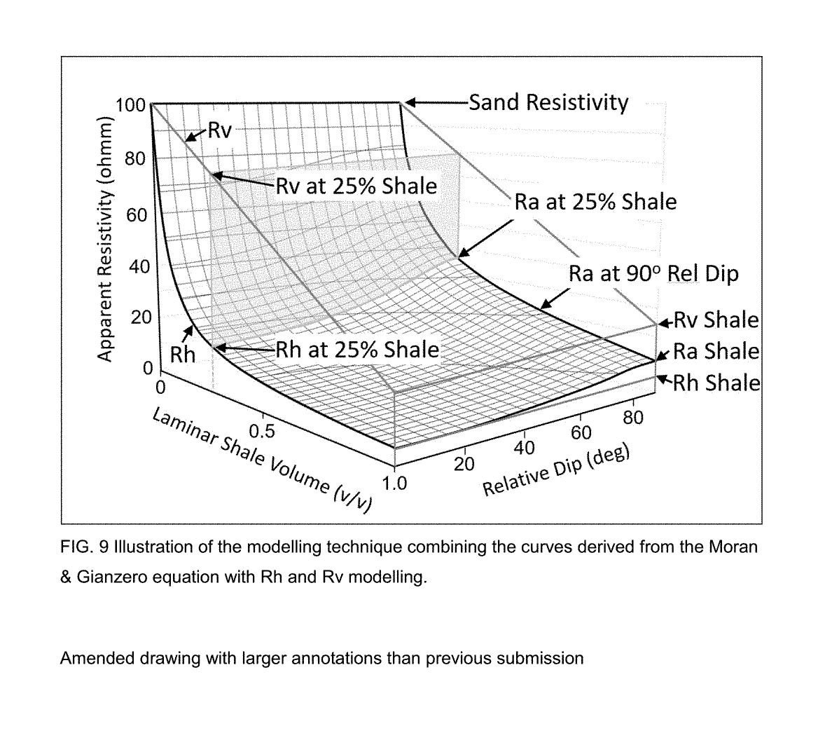

FIG. 9 is a continuation of the three-dimensional plot shown in FIG. 5. Here the Moran & Gianzero equation curves for 100% shale and for 25% laminar shale are plotted to illustrate the method of determining values for Rh and Rv at each depth depending on the value of Vsh.

### Distinguishing Between Laminar and Bioturbated Formations

The Thomas & Stieber technique is often erroneously used to distinguish between laminated shaly sands and formations with the same sand and shale content but which is not laminated, such as bioturbated formations. It attempts to split the shale content into laminar, dispersed and structural. However, the measurements used, Vsh and Porosity, are scalar and therefore not affected by formation structure. This means that if sand and shale are present in the formation, whether in extensive laminae or deformed in any way, they will always appear on the ‘laminar shale’ line on the Thomas Stieber plot.

If a formation is laminated it will show as laminated on the plot, but if it is bioturbated, or deformed in any way, it will still appear on the ‘laminar shale’ line on the plot.

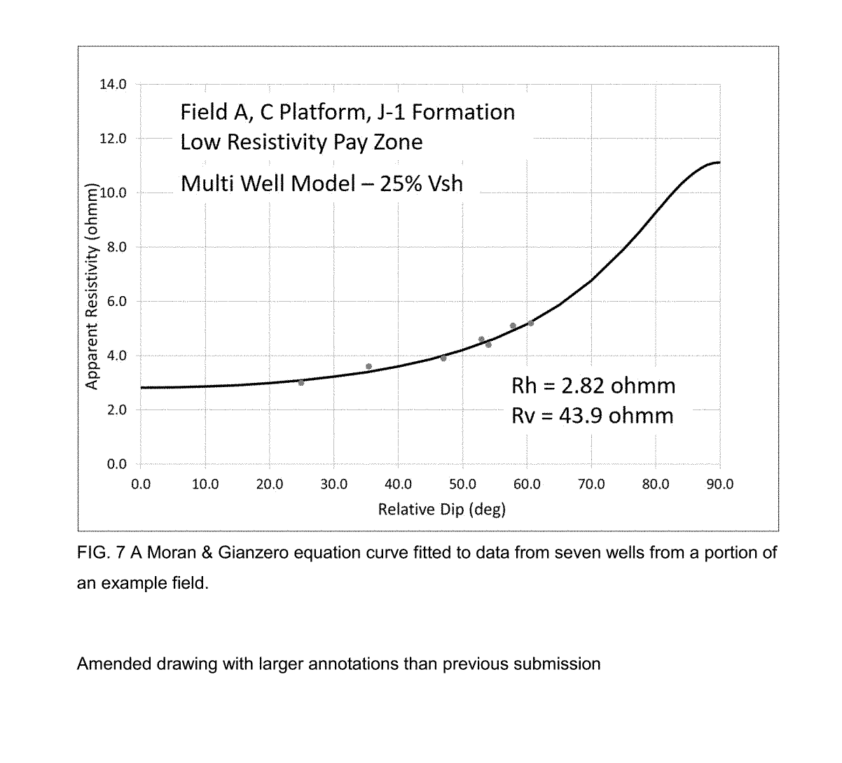

The most effective method for determining the presence of extensive laminations is by detecting electrical anisotropy. The data points shown in FIG. 7 clearly show the effects of electrical anisotropy. This confirms that this formation is laminated in this part of the field.

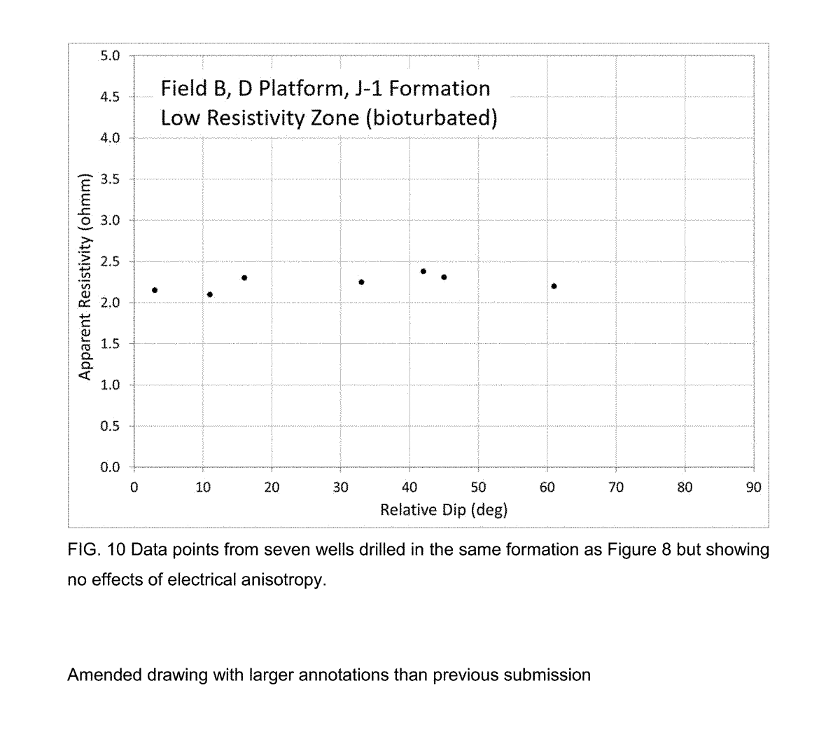

The same formation as that shown in FIG. 7 was present in a nearby field where core samples show that the formation was bioturbated. FIG. 10 shows the measurements of apparent resistivity and relative dip from that field and no anisotropy is observed.

### Interpretation of Anisotropy Results

When plotting apparent resistivity and relative dip for a specific reservoir unit it can be tempting to place all points for the field on one plot. However, this is inadvisable because there are often variations across the field, and also variations with depth due to burial and compaction. If data points are included in the curve fitting process which are not within the general trend they can have an adverse impact on the results.

Wells are grouped based on areas or compartments of the reservoir, where the formation is seen at approximately similar depths and with similar fluid saturations. Only when anisotropy is observed from a group of wells in a specific area and depth range is the process continued. When no anisotropy is observed the conventional interpretation is used for the formation. This includes intervals which may be laminated but which are either within or below the transition zone.

Once an anisotropy trend has been observed for a group of wells on a Dip/Ra plot, other wells in the area can also be included to ascertain how extensive the trend is. It is sometimes possible to map changes in the anisotropy properties across a field.

When laminar intervals are identified the wells are processed in groups with a fixed set of parameters for Rh and Rv at a certain volume of laminar shale, along with Rh_sh and Rv_sh. Calculated Rh and Rv curves are then used as input to the LSSA interpretation model.

### Laminated Shaly Sand Analysis

Laminated Shaly Sand Analysis (LSSA) is a technique developed by Mollison et al (1999), as a method of interpreting Rh and Rv logs from tri-axial induction tools in laminated formations. This is a low resolution approach, which means that it does not attempt to individually define each lamination, but instead characterizes the lithology in each layer type separately. It uses a tensor resistivity model to determine the resistivity of the resistive layers and the relative volumes of the two layer types. The resulting volume of laminar shale is then compared to an independent measure of laminar shale volume, usually from the Thomas Stieber (1975) technique.

The tensor model in LSSA is limited to working in a binary system, where only two layer types are present, usually shale and sand. If a third component, such as tight cemented layers are present, the model will predict erroneously high laminar shale volume. In this case the Thomas Stieber technique would give appropriate laminar shale volumes.

As previously described, in bioturbated formations the Thomas Stieber technique would give high laminar shale volumes while those from the tensor model would be much lower, owing to the low levels of anisotropy observed.

The strength of LSSA lies in the fact that, while both tensor and Thomas Stieber models have limitations, these are easily recognized when both techniques are used together, allowing the interpreter to better understand the formation.

Once the volumes of the layer components are determined, the sand is treated separately, with the porosity and dispersed shale content of the sand layers determined from the Thomas Stieber plot and the resistivity of the sand layers determined from the tensor model. Saturations for the sand layers are then calculated, independent of any errors which might be caused by the dominance of the shale layers on the resistivity measurements.

The LSSA technique provides a very robust interpretation of the data with few opportunities for non-unique solutions and low uncertainty.

When the LSSA technique is used on tri-axial log data it can be applied over the complete well interval to produce a continuous evaluation. However, when Rh and Rv curves are derived from resistivity anisotropy modeling they are only valid over the formation which has been modelled and any significant changes in sand porosity or fluid content above or below this formation will invalidate the curves.

### Limitations of the Technique

This technique is not a conventional log interpretation model where each well is interpreted, one at a time. Instead it uses a multi-well approach, investigating one formation at a time, and therefore it cannot be automated and requires considerable user input and control.

As with the Thomas Stieber and LSSA techniques, which are incorporated in the overall process, this technique is limited to a binary system where the laminated formation has just two components, usually sand and shale. If there is evidence to suggest that the formation is more complex a different approach is required.

There must be significant resistivity contrast between the two formation components to allow electrical anisotropy to be detected.

The formation under investigation must be laterally continuous over an area with a number of wells intersecting it at different angles of relative dip.

### SUMMARY AND CONCLUSIONS

This technique is not applicable in every mature field under review, but it does provide a reliable solution in certain cases.

The ability to differentiate between laminar and bioturbated formations is very important in the re-evaluation of mature fields where both types are present, but are impossible to tell apart from other logs.

### NOMENCLATURE FOR EQUATIONS

Rt=Conventional formation resistivity, Ohm-m
Rh=Horizontal resistivity of formation, Ohm-m
Rv=Vertical resistivity of formation, Ohm-m
Ra=Apparent resistivity of formation, Ohm-m
Rss=Resistivity of (isotropic) sand layers, Ohm-m
Rh_sh=Horizontal resistivity of shale, Ohm-m
Rv_sh=Vertical resistivity of shale, Ohm-m
Vsh=Volume of total shale, v/v
Vshl=Volume of laminar shale, v/v
Vshm=Volume of laminar shale used for modeling, v/v
Rv_m=Vertical resistivity at Vshm from modeling, Ohm-m
Rssv=Resistivity of (isotropic) sand layers at Vshm, Ohm-m
Phit=Total porosity, %
Swt=Total water saturation, %
Rv/Rh=Anisotropic ratio
λ=Coefficient of anisotropy (√Rv/Rh)
θ=Relative dip, degrees

### REFERENCES

Bittar, M. S. and Rodney, P. F., 1996, “The Effects of Rock Anisotropy on MWD Electromagnetic Wave Resistivity Sensors”, The Log Analyst, Vol. 37, No 1, pp. 20-30.
Herrick, D. C, and Kennedy, W. D., 1996, “Electrical Properties of Rocks: Effects of Secondary Porosity, Laminations, and Thin Beds”, SPWLA 37th Annual Logging Symposium, paper C, pp. 1-11.
Juhasz I., 1981, “Normalized Qv—the Key to Shaly Sand Evaluation Using the Waxman-Smits Equation in the Absence of Core Data”, SPWLA 22^{nd} Annual Logging Symposium, paper Z, pp. 1-36.
Kriegshauser, B., Fanini, O., Forgang, S., Itskovich, G., Rabinovich, M, Tabarovsky, L., Yu, L., Epov, M., and v. d. Horst, J., 2000: “A New Multicomponent Induction Logging Tool to Resolve Anisotropic Formations,” SPWLA 41st Annual Logging Symposium, paper D, pp. 1-14.
Mollison R. A., Schoen J. S., Fanini O., Kriegshauser B., Meyer W. H., Gupta P. K., 1999. “A Model for Hydrocarbon Saturation Determination from an Orthogonal Tensor Relationship in Thinly Laminated, Anisotropic Reservoirs”, SPWLA 40th Annual Logging Symposium, paper OO, pp. 1-14
Moran, J., and Gianzero, S., 1979. “Effects of Formation Anisotropy on Resistivity-Logging Measurements”, Geophysics, vol. 44, no. 7, pp. 1266-1286.
Thomas, E. and Stieber, S., 1975. “The Distribution of Shale in Sandstones and its Effect upon Porosity”, SPWLA 16th Annual Logging Symposium, Paper T, pp. 1-15.

What is claimed is:

1. The method of using the Moran & Gianzero equation and curve fitting resistivity and relative dip data points from a geological formation in multiple wells to determine Rh and Rv for that formation for each well included in the investigation.

2. The method of calculating Rh hand Rv curves for a formation based on a variable curve of volume of shale and the Rh and Rv values determined for a given shale content.

3. The method of distinguishing between laminar shaly sand formations and formations of similar shale and sand content which are not arranged in laterally extensive laminations, based on observations of electrical anisotropy from conventional resistivity measurements in multiple wells.
